(19) United States
(12) Patent Application Publication
(10) Pub. No.: US 2026/0133726 A1
(43) Pub. Date: May 14, 2026

(54) IMAGE PROCESSING APPARATUS, METHOD OF CONTROLLING IMAGE PROCESSING APPARATUS, AND STORAGE MEDIUM

(71) Applicant: CANON KABUSHIKI KAISHA, Tokyo (JP)

(72) Inventor: YASUO HIROUCHI, Ibaraki (JP)

(21) Appl. No.: 19/375,044

(22) Filed: Oct. 30, 2025

(30) Foreign Application Priority Data
Nov. 13, 2024 (JP) 2024-198194

(51) Int. Cl. G06F 3/12; H04N 1/32

(52) U.S. Cl. CPC G06F 3/1209; G06F 3/1232; H04N 1/32122; G06F 3/1287; H04N 2201/0094

(57) ABSTRACT

An image processing apparatus includes at least one memory storing instructions, and at least one processor that, upon execution of the stored instructions, configures the at least one processor to communicate with an external apparatus via a universal serial bus (USB) device interface, determine whether a scanner exists, and apply, in a case where the determination unit determines that the scanner does not exist, as configuration information regarding the USB device interface, configuration information in which an Internet Printing Protocol (IPP) over USB is set in a part of the configuration information in which a scanner I/F is set in a case where the scanner exists.

### BACKGROUND

### Field of the Technology

The present disclosure relates to an image processing apparatus, a method of controlling the image processing apparatus, and a storage medium.

### Description of the Related Art

Among image processing apparatuses such as a multi-function peripheral (MFP), there is an image processing apparatus including a universal serial bus (USB) device interface (I/F) that is connectable to an external apparatus, such as a host personal computer (PC), with a cable that conforms to a USB standard. The external apparatus and the image processing apparatus that are connected via such a USB device I/F perform communication therebetween based on a protocol conforming to a USB 2.0/USB 3.0 specification.

In USB communication, when a host PC and a USB device (e.g., an image processing apparatus) are connected via a USB cable, initial negotiation (hereinafter also referred to as enumeration) is performed. During enumeration, the USB device notifies the host PC of an I/F configuration of its own USB device I/F. With respect to the image processing apparatus as a USB device, it is possible to assume a case, as a configuration, where the image processing apparatus is an MFP equipped with a printer and a scanner, and a case where the image processing apparatus is a single-function printer (SFP) equipped with only a printer. Information regarding the I/F configuration of the USB device provided to the host PC is different between the case where the image processing apparatus is the MFP and the case where the image processing apparatus is the SFP. The image processing apparatus notifies the host PC of the I/F configuration of the USB device I/F based on the functional configuration of the image processing apparatus.

Japanese Patent Laid-Open No. 2017-142599 describes a technique regarding management for an image processing apparatus with a host operating system (OS) on a host PC side in a case where a configuration of the image processing apparatus is changed from an MFP to an SFP. Specifically, Japanese Patent Laid-Open No. 2017-142599 is seen to describe a technique in which information managed by the host OS is reupdated in a case where the configuration of the USB device I/F is changed in a state of identical USB vendor identification (ID), identical product ID, and identical USB serial ID.

It is possible for an operation form, as a selling and operation form of the image processing apparatus, where the image processing apparatus is shipped from a factory with factory settings as an MFP, and is thereafter operated as an SFP when a scanner unit is subsequently removed. Under such a situation, the host OS on the host PC side may lead to malfunctions in a case where the configuration is changed without changing the USB product ID and the USB serial ID each serving as USB device ID included in the image processing apparatus. In a case where an Internet Printing Protocol (IPP) over USB function is supported, a situation may occur where a consideration needs to be provided to a NULL I/F for a vendor class without such a function. Under such a situation, every time a new product of an SFP model with the IPP Over USB function is released, a NULL driver that supports USB product ID for the new product may need to be provided in some cases.

### SUMMARY

In consideration of the above-mentioned issue, the present disclosure is directed to a technique enabling an image processing apparatus that switches between the presence and absence of a scanner to operate as a USB device in a more suitable manner.

According to an aspect of the present disclosure, an image processing apparatus includes at least one memory storing instructions, and at least one processor that, upon execution of the stored instructions, configures the at least one processor to communicate with an external apparatus via a universal serial bus (USB) device interface, determine whether a scanner exists, and apply, in a case where the determination unit determines that the scanner does not exist, as configuration information regarding the USB device interface, configuration information in which an Internet Printing Protocol (IPP) over USB is set in a part of the configuration information in which a scanner I/F is set in a case where the scanner exists.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a hardware configuration of an image processing apparatus.

FIG. 2 is a diagram illustrating an example of a connection form between the image processing apparatus and an external apparatus.

FIG. 3 is a chart illustrating an example of a communication sequence between the image processing apparatus and the external apparatus.

FIG. 4 is a flowchart illustrating an example of processing of the image processing apparatus.

FIG. 5 is a flowchart illustrating an example of processing of the image processing apparatus.

### DESCRIPTION OF THE EMBODIMENTS

Exemplary embodiments of the present disclosure will be described in detail below with reference to the accompanying drawings.

In the present specification and the drawings, elements having substantially identical functional configurations are denoted by identical reference signs, and duplicate descriptions thereof are omitted.

For description purposes, an issue will be described that can occur in a case where an image processing apparatus serving as a multi-function peripheral (MFP) is operated as a single-function peripheral (SFP) by removing a scanner unit.

As described above, a selling and operation form of the image processing apparatus may be, an operation form where the image processing apparatus is first configured as an MFP to have factory settings or the like and is thereafter operated as an SFP by removing the scanner unit. This situation includes a case where the configuration is changed without changing USB product identification (ID) and USB serial ID each serving as USB device ID included in the image processing apparatus. Thus, when an external apparatus, such as a host personal computer (PC), has a record of being connected to the image processing apparatus at the time of operation as an MFP, there is a possibility for occurrence of a malfunction in a host operating system (OS) of the PC after the change of the configuration.

In a case of a model that supports the IPP Over USB function, a consideration may need to be provided in some cases to a NULL interface (I/F) as a USB device I/F configuration. Details of the NULL I/F will be described below. In a case where the NULL I/F for the vendor class without such a function is arranged in the USB device I/F configuration, measures may differ depending on the host OS of the host PC to be connected to the image processing apparatus.

As a specific example, in a case where the host OS is Mac OS® of Apple Inc., no issue will occur even when a vendor class driver for the Mac OS® that supports the NULL I/F does not exist.

In a case where the host OS is Windows® of Microsoft Corporation, an issue may occur in some cases when a vendor class driver for Windows® that supports the NULL I/F does not exist. In Windows®, in a case where a corresponding driver for Windows® does not exist on Alternate #0 side in the USB device I/F configuration, a “!” mark is displayed as an alert in a printer icon. This alert indicates the presence of an I/F to which a driver is yet to be allocated.

To eliminate a situation in which such an alert occurs, for example, the issue may be resolved in some cases by creating and providing a NULL driver as the vendor class driver.

A condition for Plug and Play (PnP) between the NULL I/F and the NULL driver is that USB vendor ID included in the NULL driver is matched with USB product ID information, and a USB interface number is #1.

The NULL I/F is an I/F without a function, but this configuration can cause an issue that, every time a new product of the SFP model having the IPP Over USB function is released, a NULL driver that supports the USB product ID for the new product is required to be released.

To address such an issue, a technique enabling a target image processing apparatus to operate as a USB device in a more suitable mode even under a situation where the image processing apparatus can be operated by being selectively switched between the MFP model and the SFP model is discussed.

### First Embodiment

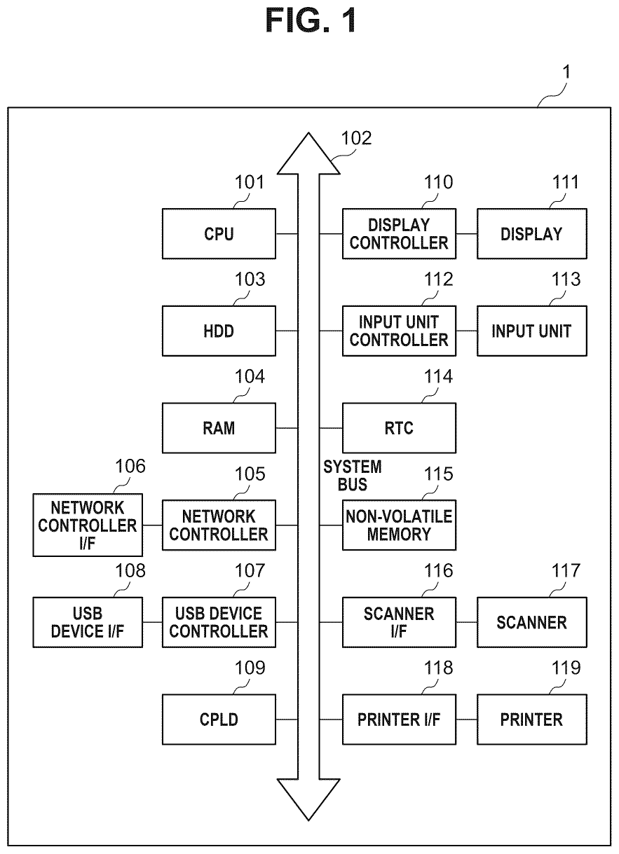

An example of a hardware configuration of an image processing apparatus 1 according to a first embodiment of the present disclosure will now be described with reference to FIG. 1.

A central processing unit (CPU) 101 executes software for operating the image processing apparatus 1.

A system bus 102 is a transmission path for transmitting/receiving various kinds of information between elements of the image processing apparatus 1, such as the CPU 101 or other elements of the image processing apparatus 1 described below.

A hard disk drive (HDD) 103 is a storage device storing software for the image processing apparatus 1, data to be used to operate the image processing apparatus 1, and temporarily stored files and the like. While the storage device of the present embodiment is the HDD 103, any storage device is applicable.

Examples of other applicable storage devices include a nonvolatile memory such as a solid-state drive (SSD) or an embedded multimedia card (eMMMC).

A random-access memory (RAM) 104 is a storage area in which a program of the image processing apparatus 1 is loaded, variables used at the time of operation of the program, data transferred from each element by a dynamic memory access (DMA), and the like are stored.

A network controller 105 controls communication between the image processing apparatus 1 and another apparatus on a network. A network controller I/F 106 is a network interface for connecting the image processing apparatus 1 to the network.

A universal serial bus (USB) device controller 107 controls communication with an external apparatus (e.g., a terminal apparatus such as a host PC 200, which will be described below) connected to the image processing apparatus 1 via a USB cable 201. A USB device I/F 108 is a connection interface for connecting another apparatus to the image processing apparatus 1 via the USB cable 201.

A display 111 is an output interface that displays various kinds of information as images to present the information to a user. A display controller 110 performs control associated with display of information on the display 111. For example, the display controller 110 can display information on the display 111 so that the user can check an operation state of the image processing apparatus 1.

An input unit 113 is an input interface that accepts an instruction from the user. The input unit 113 can be for example, a keyboard, a mouse, a numeric keypad, a cursor key, a touch panel, an operation unit keyboard, etc. When the input unit 113 is touch panel, the input unit 113 may, for example, be mounted to overlap a display area of the display 111. An input unit controller 112 controls acceptance of an instruction from the user via the input unit 113.

A real time clock 114 has a time measurement function, which implements a clock function, an alarm function, a timer function, and the like.

A non-volatile memory 115 is a storage area that can be provided other than the HDD 103 and can be implemented by a rewritable non-volatile recording medium. For example, the non-volatile memory 115 may be a static random-access memory (SRAM), an electrically erasable programmable read-only memory (EEPROM), or the like.

A complex programmable logic device (CPLD) 109 reads a low/high state of a signal line on a substrate circuit via the CPU 101 and changes a setting of the low/high state by the CPU 101.

The image processing apparatus 1 is connected with a scanner 117 via a scanner I/F 116. In a case where the image processing apparatus 1 operates as an SFP model without a scanner, the scanner 117 may not be connected.

The image processing apparatus 1 is also connected with a printer 119 via a printer I/F 118.

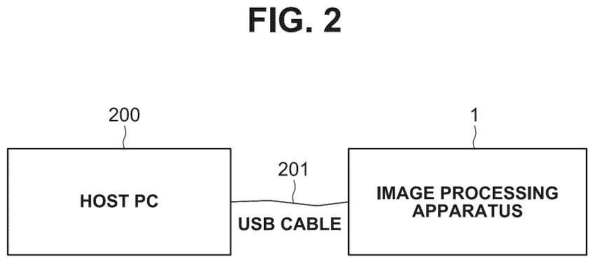

An example of a connection between the host PC 200 and the image processing apparatus 1 will now be described with reference to FIG. 2. The host PC 200 is connected to and communicates with the image processing apparatus 1 via the USB cable 201.

The USB device I/F 108 in the image processing apparatus 1 includes, for example, an I/F for implementing page description language (PDL) print. The PDL print is a function of executing print using a printer driver provided by a vendor and installed in the host PC 200. The I/F is also hereinafter referred to as a legacy PDL I/F.

The USB device I/F 108 in the image processing apparatus 1 with the scanner 117 also includes an I/F for implementing a function of reading a scanned image by using a class driver provided by a vendor and installed in the host PC 200.

The following Table 1 describes an example of the USB device I/F 108 having this configuration.

TABLE 1

Interface

| | | #0 | #1 |
|---|---|---|---|
| Alternate | #0 | Scanner I/F | Legacy PDL I/F |
| | | (Vendor Class) | (Printer Class 7-1-2) |
| | #1 | — | — |

The terms included in Table 1 will be explained below.

The USB device I/F 108 includes interfaces indicating functions. One of the functions is implemented by using one interface number. “Alternate” means switching. From the host PC 200, only one function with respect to one interface can be seen. The host PC 200 can normally use a function arranged in “Alternate” number #0. In a case of using the function arranged in “Alternate” number #1, the host PC 200 uses, for example, a command called SET_INTERFACE by a control transfer to designate an “Interface” number and an “Alternate” number for the target function. Since no interface exists on the Alternate number #1 side in the configuration illustrated in Table 1, the host PC 200 does not transmit the SET_INTERFACE command.

In a USB specification, a scanner class does not exist. Thus, an I/F for using the scanning function is implemented by using, for example, a vendor class controlled by a protocol that can be defined by a vendor.

The USB specification has a printer class for implementing print from the host PC 200. In a portion “7-1-2” in the definition of “Printer Class 7-1-2”, “7” represents a printer class, “1” represents a printer subclass, and “2” represents interactive communication.

From among image processing apparatuses, there exists an apparatus of a printer model without a scanner. The following Table 2 illustrates an example of a configuration of a USB device I/F in a case where the scanner does not exist.

TABLE 2

Interface

| | | #0 | #1 |
|---|---|---|---|
| Alternate | #0 | Legacy PDL I/F | — |
| | | (Printer Class 7-1-2) | |
| | #1 | — | — |

In the configuration illustrated in Table 2, a scanner I/F does not exist as compared with the configuration illustrated in Table 1. Thus, “Interface” number of the legacy PDL I/F is #0.

A function called Internet Printing Protocol (IPP) over USB (IPP Over USB) that enables the print function and the scanning function from the host PC 200 has also been proposed in recent years. This IPP Over USB is a technique of implementing the IPP technique via USB. The IPP technique makes the print function and the scanning function available using Ethernet or a network via Wireless Fidelity (Wi-Fi®).

In an image processing apparatus that supports the IPP Over USB function, a USB interface configuration other than the configuration illustrated in Table 1 is required. The following Table 3 illustrates an example of a USB device I/F configuration in a case where the IPP Over USB function is supported.

TABLE 3

Interface

| | | #0 | #1 |
|---|---|---|---|
| Alternate | #0 | Scanner I/F | Legacy PDL I/F |
| | | (Vendor Class) | (Printer Class 7-1-2) |
| | #1 | IPP Over USB | IPP Over USB |
| | | (Printer Class 7-1-4) | (Printer Class 7-1-4) |

The terms in Table 3 will be explained below. In a portion “7-1-4” in the definition of “Printer Class 7-1-4”, “7” represents a printer class, “1” represents a printer subclass, and “4” represents the IPP Over USB.

Print using the IPP Over USB or utilization of the scanning function using the IPP Over USB is implemented by a printer class driver that conforms with a standard IPP Over USB and is provided by the host OS.

From among image processing apparatuses that support the IPP Over USB, a model without a scanner exists. In such a case, for example, it is desirable to implement an I/F configuration illustrated in the following Table 4. Interface #1/Alternate #0, which means a blank configuration without an I/F, is not permitted in the USB specification.

TABLE 4

Interface

| | | #0 | #1 |
|---|---|---|---|
| Alternate | #0 | Legacy PDL I/F | — |
| | | (Printer Class 7-1-2) | |
| | #1 | IPP Over USB | IPP Over USB |
| | | (Printer Class 7-1-4) | (Printer Class 7-1-4) |

Given such a situation, an example of a USB device I/F configuration of an image processing apparatus that supports the IPP Over USB and does not have a scanner is illustrated in the following Table 5.

TABLE 5

Interface

| | | #0 | #1 |
|---|---|---|---|
| Alternate | #0 | Legacy PDL I/F | NULL IF |
| | | (Printer Class 7-1-2) | (Vendor Class) |
| | #1 | IPP Over USB | IPP Over USB |
| | | (Printer Class 7-1-4) | (Printer Class 7-1-4) |

A NULL I/F illustrated in Table 5 corresponds to a vendor class I/F that does not have a printer function, a scanning function, or any other function.

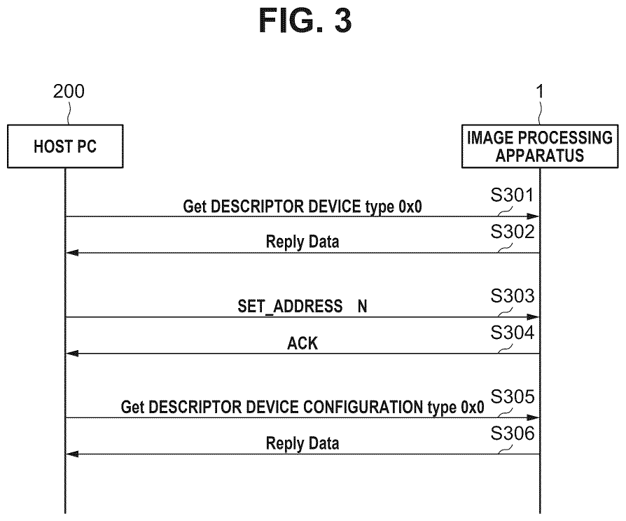

A description of an example of an initial part of a sequence of enumeration that is executed first when the image processing apparatus 1 and the host PC 200 are connected to each other with the USB cable 201 will now be provided with reference to FIG. 3. The sequence illustrated in FIG. 3 is a sequence executed in a case where the image processing apparatus 1 according to the present embodiment is implemented, as well as in the USB standard.

In step S301, the host PC 200 transmits, when detecting connection to the USB device, to the image processing apparatus 1 a command “Get DESCRIPTOR DEVICE type 0X0” for determining a device type.

In step S302, upon receiving the command transmitted from the host PC 200 in step S301, the image processing apparatus 1 returns a response to the command to the host PC 200. This response includes, for example, USB vendor ID, USB product ID included as identifiers as the USB device in the image processing apparatus 1, and other performance information regarding a USB such as “USB 2.0 support”.

In step S303, since the host PC 200 has recognized the image processing apparatus 1 as the USB device, the host PC 200 provides the image processing apparatus 1 a unique address on a USB bus (address N in FIG. 3) to enable the host PC 200 to communicate with the image processing apparatus 1 as the USB device.

In step S304, the image processing apparatus 1 transmits an ACK response to the host PC 200 to notify the host PC 200 of the address N.

In step S305, the host PC 200 transmits, to the image processing apparatus 1, a “Get DESCRIPTOR DEVICE CONFIGURATION type 0X0” command for acquiring detailed information including a USB device I/F configuration.

In step S306, the image processing apparatus 1 returns, to the host PC 200, I/F configuration information and other detailed information as a response to the command received in step S305. At this time, for example, in a case where the image processing apparatus 1 is operating as the MFP model having the IPP Over USB function, the image processing apparatus 1 returns the I/F configuration information illustrated in Table 3 and other detailed information. Based on the response information received in steps S302 and S306, the host PC 200 can understand USB identification information and the USB device I/F configuration regarding the image processing apparatus 1.

In a case where the image processing apparatus 1 is the SFP model having the IPP Over USB function, the present embodiment provides a solution by setting a USB device I/F configuration illustrated in the following Table 6.

TABLE 6

Interface

| | | #0 | #1 |
|---|---|---|---|
| Alternate | #0 | IPP Over USB | Legacy PDL I/F |
| | | (Printer Class 7-1-4) | (Printer Class 7-1-2) |
| | #1 | — | IPP Over USB |
| | | | (Printer Class 7-1-4) |

The configuration has been conventionally employed in which the legacy PDL I/F is arranged in Interface #0/Alternate #0 and the NULL I/F is arranged in Interface #1/Alternate #0 as illustrated in Table 5. Additionally, the configuration in which the IPP Over USB is arranged in Interface #0/Alternate #1 and Interface #1/Alternate #1 has been employed.

In the present embodiment, the NULL I/F is no longer arranged, and the legacy PDL I/F is arranged in Interface #1/Alternate #0. The issue is then solved by the configuration in which the IPP Over USB is arranged in Interface #0/Alternate #0 and Interface #1/Alternate #1.

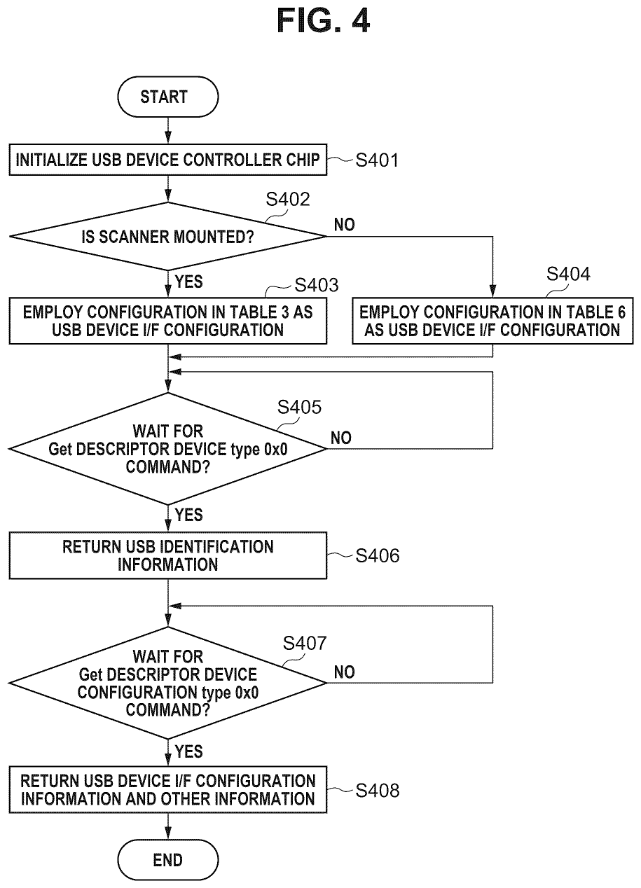

A description of an example of processing of the image processing apparatus 1 according to the present embodiment with a focus on processing in a case where the image processing apparatus 1 employs a specification with the IPP over USB function will now be provided with reference to the flowchart in FIG. 4.

In step S401, the CPU 101 in the image processing apparatus 1 executes processing of initializing a USB device controller chip upon starting of the image processing apparatus 1.

In step S402, the CPU 101 determines whether the scanner 117 is mounted on the image processing apparatus 1 (presence/absence of the scanner 117).

In a case where the CPU 101 determines that the scanner 117 is mounted on the image processing apparatus 1 (the scanner 117 exists) (YES in step S402), the processing proceeds to step S403. In step S403, the CPU 101 determines the USB device I/F configuration to have the configuration illustrated in Table 3.

In a case where the CPU 101 determines that the scanner 117 is not mounted on the image processing apparatus 1 (the scanner 117 does not exist) (NO in step S402), the processing proceeds to step S404. In step S404, the CPU 101 determines the USB device I/F configuration to have the configuration illustrated in Table 6.

In step S405, the CPU 101 waits for transmission of the Get DESCRIPTOR DEVICE type 0x0 command from the host PC 200. When the CPU 101 receives the command from the host PC 200 (YES in step S405), the processing proceeds to step S406.

In step S406, the CPU 101 returns the USB identification information (USB vendor ID, USB product ID, USB performance, and the like) included in the image processing apparatus 1 to the host PC 200.

In step S407, the CPU 101 waits for transmission of a Get DESCRIPTOR DEVICE CONFIGURATION type 0x0 command from the host PC 200. When the CPU 101 receives the command from the host PC 200 (YES in step S407), the processing proceeds to step S408.

In step S408, the CPU 101 returns the USB device I/F information determined in the processing in step S403 or S404 to the host PC 200.

Transmission/reception of a command is also performed between the host PC 200 and the image processing apparatus 1 as a USB enumeration operation. A description of processing associated with transmission/reception of the command will be omitted.

Executing the processing illustrated in FIG. 4 enables preventing a malfunction of the host OS even in a case where, for example, the image processing apparatus 1 is changed from the MFP model to the SFP model. There is no need for releasing the NULL driver that supports a new model every time, even in a case where a newer version of the image processing apparatus 1 is released.

### Second Embodiment

A second embodiment of the present disclosure will now be described. In the above-described method described of the first embodiment, a description was provided of an example in which the USB device I/F configuration information illustrated in Table 6 is returned, as the configuration of the image processing apparatus 1, to the host PC 200 in a case where the scanner 117 is not mounted and the IPP over USB function is valid. In the second embodiment, a description will be provided of an example in a case where USB device I/F configuration information other than that illustrated in Table 6 is returned.

Specifically, the present embodiment provides a solution performed by setting a USB device I/F configuration illustrated in the following Table 7 in the SFP model having the IPP Over USB function.

TABLE 7

| | | Interface | | |
|---|---|---|---|---|
| | | #0 | #1 | #2 |
| Alternate | #0 | IPP Over USB | Legacy PDL I/F | IPP Over USB |
| | | (Printer Class 7-1-4) | (Printer Class 7-1-2) | (Printer Class 7-1-4) |
| | #1 | — | — | — |

The first embodiment described a configuration in which the legacy PDL I/F is arranged in Interface #0/Alternate #0 and the NULL I/F is arranged in Interface #1/Alternate #0 as illustrated in Table 5. The configuration in which the IPP Over USB is also arranged in Interface #0/Alternate #1 and Interface #1/Alternate #1 is implemented.

In the present embodiment, the NULL I/F is no longer arranged, the legacy PDL I/F is arranged in Interface #1/Alternate #0, and the configuration in which the IPP over USB is arranged in Interface #0/Alternate #0 and Interface #2/Alternate #0 is implemented.

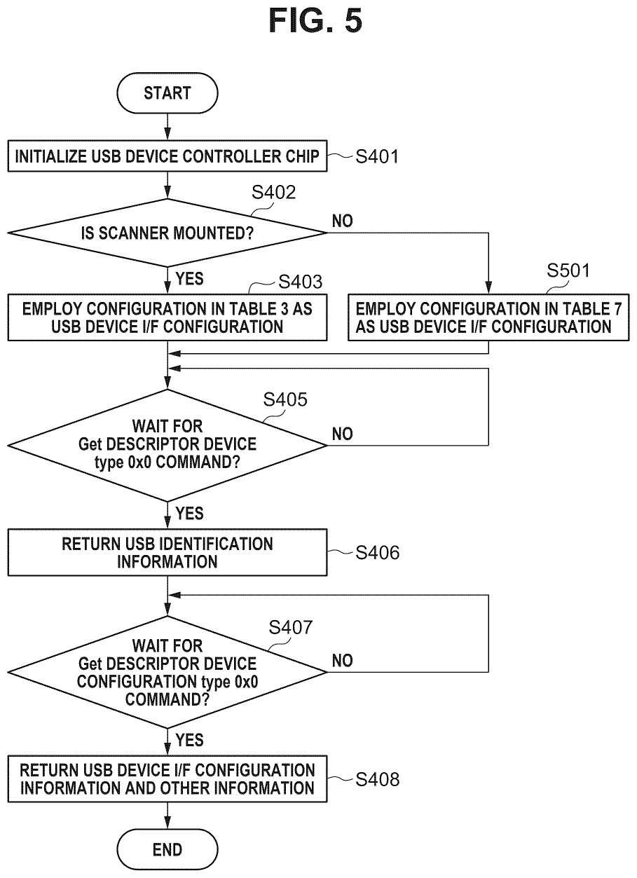

An example of processing of the image processing apparatus 1 according to the present embodiment will now be described with reference to the flowchart in FIG. 5. The example illustrated in FIG. 5 differs from the example illustrated in FIG. 4 in the processing in step S501. The following description of the processing of FIG. 5 is provided with a focus on the differences from the processing in FIG. 4, and a detailed description of the processing in FIG. 5 substantially similar to the processing in FIG. 4 will be omitted.

In a case where the CPU 101 determines that the image processing apparatus 1 has a configuration in which the scanner 117 is not mounted thereon (NO in step S402), the processing proceeds to step S501.

In step S501, the CPU 101 determines the USB device I/F configuration to have the configuration illustrated in Table 7.

The processing in subsequent steps S405 to S408 is similar to that in the above-described first embodiment.

Executing the processing illustrated in FIG. 5 enables preventing failure of the host OS even in a case where, for example, the image processing apparatus 1 is changed from the MFP model to the SFP model. There is no need for releasing the NULL driver that supports newer models of the image processing apparatus 1 every time, even when a newer version is released.

According to the present disclosure, it is possible to operate an image processing apparatus that switches between the presence and absence of a scanner acting as a USB device in a more suitable manner.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-198194, filed Nov. 13, 2024, which is hereby incorporated by reference herein in its entirety.

What is claimed is:

1. An image processing apparatus comprising:
at least one memory storing instructions; and
at least one processor that, upon execution of the stored instructions, configures the at least one processor to:
communicate with an external apparatus via a universal serial bus (USB) device interface;
determine whether a scanner exists; and
apply, in a case where the determination unit determines that the scanner does not exist, as configuration information regarding the USB device interface, configuration information in which an Internet Printing Protocol (IPP) over USB is set in a part of the configuration information in which a scanner I/F is set in a case where the scanner exists.

2. The image processing apparatus according to claim 1, wherein in a case where it is determined that the scanner does not exist, apply, as the configuration information regarding the USB device interface, configuration information in which the IPP Over USB is set in the part of the configuration information in which the scanner I/F is set and the IPP Over USB is set in an Interface #2/Alternate #0 configuration.

3. The image processing apparatus according to claim 1, wherein in a case where it is determined that the scanner does not exist, apply, as the configuration information regarding the USB device interface, configuration information in which the IPP Over USB is set in an Interface #0/Alternate #0 configuration.

4. A method of controlling an image processing apparatus, the method comprising:
communicating with an external apparatus via a universal serial bus (USB) device interface;
determining whether a scanner exists; and
performing control to, in a case where it is determined that the scanner does not exist, apply, as configuration information regarding the USB device interface, configuration information in which an Internet Printing Protocol (IPP) Over USB is set in a part of the configuration information in which a scanner I/F is set in a case where the scanner exists.

5. A non-transitory computer readable storage medium storing a program for causing an image processing apparatus to perform a method, the method comprising:
communicating with an external apparatus via a universal serial bus (USB) device interface;
determining whether a scanner exists; and
performing control to, in a case where it is determined that the scanner does not exist, apply, as configuration information regarding the USB device interface, configuration information in which an Internet Printing Protocol (IPP) Over USB is set in a part of the configuration information in which a scanner I/F is set in a case where the scanner exists.
